(19) United States
(12) Patent Application Publication
(10) Pub. No.: US 2026/0344577 A1
(43) Pub. Date: Nov. 5, 2026

(54) METHOD FOR PERFORMING A BRAKING OPERATION OF BLADE CARRIER IN A CUTING ASSEMBLY OF A POWER TOOL, ASSEMBLY, ARRANGEMENT, AND POWER TOOL

(71) Applicant: Andreas Stihl AG & Co. KG, Waiblingen (DE)

(72) Inventors: Tim Däweritz, Waiblingen (DE); Patrick Wiesa, Besigheim (DE)

(73) Assignee: Andreas Stihl AG & Co. KG, Waiblingen (DE)

(21) Appl. No.: 19/655,048

(22) Filed: Apr. 22, 2026

(30) Foreign Application Priority Data
Apr. 30, 2025 (DE) 10 2025 116 717.6
Apr. 30, 2025 (DE) 10 2025 116 718.4

(51) Int. Cl. A01G 3/053; A01D 34/14; A01D 34/40; A01G 3/04

(52) U.S. Cl. CPC A01G 3/053; A01D 34/14; A01D 34/40; A01G 2003/0461

(57) ABSTRACT

A method is proposed for performing a braking operation of at least a first blade carrier in a cutting assembly of a power tool, wherein the first blade carrier is set into a working movement by means of a drive unit and, in response to a command, the braking operation of at least the first blade carrier is performed in such a way that the first blade carrier is brought to a standstill in a predetermined rest position, wherein the predetermined rest position is reached at least partially and/or temporarily by driving the first blade carrier by means of the drive unit during at least a specific phase of the braking operation. The disclosure also relates to an assembly configured to carry out such a method and to an arrangement comprising such an assembly. The disclosure further relates to a power tool comprising such an assembly or arrangement.

### CROSS-REFERENCE TO RELATED APPLICATIONS

This application claims priority of German Patent Application No. 10 2025 116 718.4, filed on Apr. 30, 2025, and German Patent Application No. 10 2025 116 717.6, filed on Apr. 30, 2025. The disclosures of these prior applications are considered part of the disclosure of this application and are hereby incorporated by reference in their entireties.

### FIELD

The present disclosure relates to a method for performing a braking operation of at least a first blade carrier in a cutting assembly of a power tool. The disclosure also relates to an assembly configured to carry out such a method, and to an arrangement comprising such an assembly. The invention also relates to a power tool comprising such an assembly or arrangement.

### BACKGROUND

Hedge trimmers comprise a cutting assembly for trimming hedges, shrubs and the like. Typically, a plurality of blades are formed on two movable blade carriers arranged one above the other in such a cutting assembly. If the two blade carriers together with their blades are moved against each other, two blades from different blade carriers work together in pairs and temporally, thus functionally implementing a plurality of shears.

However, it has been found to be disadvantageous with previously known cutting assemblies that cleaning the components of the cutting assembly, in particular the blades, may be comparatively complex. In addition, the blades may sometimes stick relatively easily due to remaining plant residues as well as residues of resin and other plant juices, which may increase the cleaning and maintenance effort. Similar observations have also been made with power tools with previously known cutting assemblies.

### SUMMARY

According to a first aspect, the disclosure proposes a method for performing a braking operation of at least a first blade carrier in a cutting assembly of a power tool, wherein the first blade carrier is set into a working movement by means of a drive unit and, in response to a command, the braking operation of at least the first blade carrier is performed in such a way that the first blade carrier is brought to a standstill in a predetermined rest position, wherein the predetermined rest position is reached at least partially and/or temporarily by driving the first blade carrier by means of the drive unit during at least a specific phase of the braking operation.

The disclosure is based on the surprising finding that by driving the first blade carrier, changes in its braking distance due to time-dependent factors, such as, for example, the first blade carrier becoming stuck with resin, may be counteracted. Consequently, by driving the first blade carrier accordingly during the specific phase, it is advantageously possible to approach the predetermined rest position of the first blade carrier in a targeted manner, even under changing influencing factors. This also allows the blades arranged on the first blade carrier to be brought to a standstill in a defined position, which, for example, provides in particular, good accessibility to the individual blades and thus enables easier cleaning of the blades.

Driving the first blade carrier may be easily retrofitted and applied even in existing arrangements that already comprise a cutting assembly with associated drive unit. This makes the method in particular attractive from an economic standpoint. For example, the proposed method may be implemented very economically in existing arrangements subsequently through a software update of the components controlling the braking operation.

Performing the braking operation may involve or constitute a control and/or regulation of the movement of at least the first blade carrier.

The specific phase may be defined, for example, by a particular segment of the profile of an operating parameter of the drive unit or its components during the braking operation. For example, within this segment, the operating parameter may exceed a first threshold value and/or fall below a second threshold value and/or deviate from a predetermined profile. Alternatively or additionally, the specific phase may be defined by a time period, in particular starting with the braking.

Driving advantageously takes place throughout the entire duration of the specific phase.

In some examples, there is exactly one specific phase of the braking operation. In other implementations, however, two or more specific phases of the braking operation may be provided.

Driving the first blade carrier by means of the drive unit is understood to mean, in particular, that the first blade carrier is actively driven in such a way that any negative acceleration of the first blade carrier is reduced in terms of magnitude, at least temporarily. In other words, the intensity with which the first blade carrier is braked is reduced without accelerating it positively. Put another way, during the driving of the first blade carrier by means of the drive unit, the profile of the rotational speed of the drive unit or its components (such as a motor) follows a characteristic curve that does not increase (and thus, in particular, comprises either a decreasing or a horizontal profile in each section). In particular, electrical energy is supplied for the purpose of driving the drive unit during driving, for example, from an energy storage device such as a battery, which is associated to and/or comprised by the drive unit.

Driving the first blade carrier by means of the drive unit advantageously extends the overall braking duration compared to braking without driving. This ensures that the predetermined rest position may be reliably reached.

Alternatively or additionally, it may also be provided that the braking operation is performed as a function of at least one operating parameter of a motor of the drive unit and/or at least one characteristic variable of the first blade carrier, wherein in particular the operating parameter is a rotational speed and/or a position of the motor and/or the characteristic variable is a position of the first blade carrier.

Based on the motor's operating parameter, advantageously, conclusions may be drawn about the position of the first blade carrier and thus about the position of the blades carried by it. By consequently performing the braking operation while taking into account one or more operating parameters of the motor, it is possible to approach the predetermined rest position of the first blade carrier reliably.

Above all, the operating parameter may be used to advantageously and very reliably detect one or more influencing factors acting on the first blade carrier, at least implicitly, and thus take these into account when performing the braking operation. This allows the effects of these influencing factors on the braking operation to be fully or partially compensated for. This may be very advantageous in approaching the predetermined rest position.

In this context, it has proven to be particularly advantageous that the operating parameter is usually provided by the drive unit anyway, in particular it may be decoupled from it as an operating parameter signal. The operating parameter may then be evaluated in a particular simple way and a result of this evaluation may be used very easily to perform the braking operation. In doing so, in particular, no additional sensors are required. Thereby, costs and maintenance effort associated with electrical sensor components are reduced and reliability is increased.

Therefore, it may be advantageously provided that the braking operation is performed at least partially as a function of an operating parameter signal, in particular as a function of an evaluation of the operating parameter signal.

Similarly, the characteristic variable may also be advantageously included for this purpose, either alternatively or additionally. In this case, sensors may be expediently used to monitor the first blade carrier, allowing the characteristic variable to be determined. For example, a characteristic variable signal may be obtained and evaluated by means of the sensors, and a result of this evaluation may be very advantageously used to perform the braking operation.

The position of the motor may, for example, be a position (such as a value in the range [0 . . . 2π]) of a shaft and/or a rotor of the motor, in particular a relative position. This (especially the position of the motor shaft) will be explained in more detail below.

The operating parameter is advantageously a variable, in particular an electrical variable, of the drive unit or parts thereof, which is and/or may be detected by means of sensors and/or evaluated by means of electrical measuring technology

The operating parameter signal may, for example, be a control unit signal of a control unit of the motor and/or represent time-dependent values of the operating parameter.

Advantageously, the operating parameter signal, in particular in the form of a control unit signal of the control unit of the motor, is obtained, in particular received, such as from the control unit, and/or evaluated. The braking operation is then advantageously performed at least partially as a function of a result of the evaluation.

For example, the operating parameter signal may comprise a time-dependent, periodic and/or sinusoidal signal profile. The operating parameter signal is advantageously a discrete-time signal.

The control unit of the motor may, for example, be a motor control of the motor.

It may be particularly advantageously provided to preprocess the operating parameter signal, in particular by performing at least smoothing, filtering and/or normalizing the operating parameter signal.

In particular, the operating parameter signal may be preprocessed in terms of signal technology.

When this application refers to the braking operation being performed as a function of a parameter, a variable, a result or something else, this is understood in particular to mean that the braking operation is performed explicitly or implicitly as a function of the respective parameter, the respective variable, the respective result or something else, unless the context indicates otherwise.

Advantageously it may be provided that during the specific phase a profile of the rotational speed of the motor describes a non-increasing characteristic curve, in particular a characteristic curve that is either decreasing or horizontal in each section.

Alternatively or additionally, it may also be provided that, temporarily after the command, in particular in response to the command, at least one value of the operating parameter and/or the characteristic variable is determined, and that a duration of the specific phase and/or a drive intensity of the first blade carrier by means of the drive unit is determined based on the value of the operating parameter and/or the characteristic variable.

This makes it possible to perform the braking operation in a in particular targeted manner.

For example, the command may trigger the determination of the value.

Alternatively or additionally, it may also be provided that the cutting assembly comprises a counter element to the first blade carrier, such as a second blade carrier or a cutting edge carrier, and in particular that the operating parameter and/or the characteristic variable or a variable derived therefrom is a measure of friction between the first blade carrier and the counter element.

This allows for a counteracting of the first blade carrier's rapid braking due to friction by appropriately choosing the drive intensity. For example, if there is comparatively high friction between the first blade carrier and the counter element, driving may be performed more strongly, compared to a situation with comparatively low friction between the first blade carrier and the counter element. In both cases, however, the predetermined rest position may be reliably reached, as the different friction levels may be fully or partially compensated for by adjusting the driving to match the specific friction.

Further details regarding the cutting assembly will be discussed in more detail below.

Alternatively or additionally, it may also be provided that the drive intensity is varied as a function of time during the specific phase.

For this purpose, in some examples, the value of the operating parameter and/or the value of the characteristic variable may be repeatedly determined (in particular, at least partially during the specific phase), and the drive intensity of the first blade carrier by means of the drive unit may be adjusted as a function of time based on the values of the operating parameter and/or the characteristic variable. This allows, for example, a time-dependent influencing factor to be taken into account. For example, friction between the first blade carrier and the counter element may be position-dependent and therefore vary as a function of time during braking. This variation in friction during the braking operation may be taken into account and fully or partially compensated for by varying the drive intensity as a function of time.

It may therefore be advantageous to vary a drive intensity of the first blade carrier by means of the drive unit at least partially during the specific phase, based on at least two of the repeatedly determined values of the operating parameter and/or the characteristic variable, as a function of time.

Alternatively or additionally, it may also be provided that the predetermined rest position is reached at least partially and/or temporarily by driving the first blade carrier by means of the drive unit during at least two specific phases of the braking operation, wherein, in particular, at least two of the at least two specific phases do not follow each other immediately in terms of time.

For example, at least two (or more than two) specific phases may be provided, each separated by a time interval. This means that the end of the first specific phase is followed only after a certain time interval by the start of the immediately following, second specific phase. This allows, for example, an influence on the braking operation that occurs repeatedly but only temporarily to be reliably taken into account.

It is advantageous if, in a first specific phase, a first driving of the first blade carrier is performed by means of the drive unit, and in a second specific phase, a second driving of the first blade carrier is performed by means of the drive unit. The first and second driving may each be varied as a function of time. The previously described selection of the drive intensity may advantageously be performed individually for each of the specific phases.

Alternatively or additionally, it may also be provided that the duration of all of the at least one specific phase is less than the duration of the braking operation, wherein the duration of all of the at least one specific phase is in particular at most 95% of the duration of the braking operation and/or at least 1% of the duration of the braking operation.

This allows the braking operation to be performed reliably.

If only a single specific phase is provided during the braking operation, the relevant duration of all specific phases (of the at least one specific phase) may expediently correspond to the duration of the (then single) specific phase discussed above, determined on the basis of the value of the operating parameter and/or the characteristic variable.

For example, the duration of all of the at least one specific phase may be at most 80%, at most 70% or at most 50% of the duration of the braking operation.

The duration of the braking operation may be determined, for example, by a time span between the time of the start of braking based on the working movement and the time of reaching the predetermined rest position.

Alternatively or additionally, it may also be provided that the first part of the braking operation discussed below comprises the specific phase, and in particular (i) the specific phase represents a start or an end of the first part of the braking operation, or (ii) the specific phase is separated from the start and the end of the first part of the braking operation in terms of time.

It is particularly advantageous if all specific phases of the at least one specific phase are within the first part of the braking operation.

The specific phase expediently then represents a start or an end of the first part of the braking operation if, accordingly, a start or an end of the specific phase is identical to the start or the end of the first part of the braking operation.

According to a second aspect, the disclosure proposes a method for performing a braking operation of at least a first blade carrier in a cutting assembly of a power tool, wherein the first blade carrier is set into a working movement by means of a drive unit and, upon a command, the braking operation of at least the first blade carrier is performed in such a way that the first blade carrier is brought to a standstill in a predetermined rest position, wherein, in response to the command, a position of a motor of the drive unit and/or a position of the first blade carrier is determined, and the motor is operated, at least temporarily during the braking operation, at least implicitly, as a function of the determined motor position and/or position of the first blade carrier.

The disclosure is therefore based on the surprising finding that the braking operation may be controlled in particular reliably by considering the motor position and/or the position of the first blade carrier. By performing the braking operation in conjunction with this one or more positions, it is possible to reliably approach a predetermined rest position of the first blade carrier. This also allows the blades arranged on the first blade carrier to be brought to a standstill in a defined position, which, for example, provides in particular good access to the individual blades and thus facilitates easier cleaning.

In this case, operating the motor accordingly, may otherwise also be easily retrofitted and applied in existing arrangements that comprise a cutting assembly and associated drive unit. This makes the method in particular attractive from an economic standpoint. For example, the proposed method may be implemented very economically in existing arrangements subsequently by means of a software update of the components controlling the braking operation.

Performing the braking operation may comprise or represent control and/or regulation of the movement of at least the first blade carrier.

Alternatively or additionally, it may also be provided that a time course of the rotational speed of the motor is determined as a rotational speed profile, and that the motor is operated at least temporarily during the braking operation according to the rotational speed profile.

For example, the rotational speed profile may be determined by loading it from memory. For example, the same rotational speed profile may always be determined (such as loaded from the memory). Alternatively, the rotational speed profile may be selected from a plurality of predefined rotational speed profiles and determined in this way. It is also possible to determine the rotational speed profile by calculating it using an equation.

Operating the motor according to the rotational speed profile expediently leads to a braking of the first blade carrier.

Operating the motor according to the rotational speed profile comprises advantageously that the rotational speed does not increase. For example, operating the motor according to the rotational speed profile may comprise a continuous reduction in the rotational speed at least temporarily and/or comprise temporarily to keep the rotational speed constant. This ensures that the rotational speed of the motor decreases over time and thus brakes the first blade carrier.

Braking according to the rotational speed profile has the advantage that the end position of the motor, and therefore that of the first blade carrier, may be reliably predicted. If, for example, the motor speed profile (which may be stored in and/or provided to a motor's control unit) requires seven motor revolutions to brake to a standstill, then the braking operation may be initiated seven motor revolutions before the desired end position (it is possible in this case that after receiving the command to initiate the braking operation, a certain number of motor revolutions will be delayed before braking starts, as explained in more detail below). Therefore, in this case, expediently the braking operation may be started every seven motor revolutions to brake the first blade carrier into the correct position. If the braking command is received at an “unsuitable” motor position, the motor may expediently continue to rotate until a suitable motor position for initiating braking is reached.

Alternatively or additionally, it may also be provided that the rotational speed profile is determined as a function of the determined motor position and/or position of the first blade carrier and/or the predetermined rest position.

The rotational speed profile may advantageously be selected from a plurality of predefined rotational speed profiles and/or loaded from the memory, as a function of the determined motor position and/or position of the first blade carrier.

It is particularly advantageous if the rotational speed profile is determined by adjusting a standard rotational speed profile as a function of the determined motor position and/or position of the first blade carrier.

It is also possible to determine the rotational speed profile by calculating it, at least partially, based on an equation, wherein the equation includes at least one of the following variables: the determined motor position, the position of the first blade carrier, a defined maximum negative acceleration of the motor and/or the predetermined rest position.

Alternatively or additionally, it may also be provided that, in response to the command, a start time of a braking of the first blade carrier is adjusted based on the rotational speed profile according to a time interval selected as a function of the determined motor position and/or position of the first blade carrier and/or the rotational speed profile.

This allows taking into account varying braking of the first blade carrier due to different influences (e.g., friction). The braking, based on the rotational speed profile, which is optionally performed identically regardless of any influences, may be shifted in terms of time.

Adjusting the start time of the braking according to the selected time interval may, for example, correspond to a shift in the start time of the braking. This allows for a positive (or, in principle, also a negative) time delay before the braking starts. The start time is thus shifted backward (positive delay) or forward (negative delay). Of course, advancing the start time is only possible up to a point in time when, for example, a command to initiate the braking operation already exists.

Optionally, the braking of the first blade carrier is performed identically based on the rotational speed profile, independent of external influencing factors (such as, for example, friction between the first blade carrier and the counter element). In other words, as long as the braking is performed based on the rotational speed profile, the rotational speed of the motor follows this rotational speed profile (especially independently of external influences). This does not preclude the possibility of further braking of the first blade carrier during the braking operation, which may vary as a function of the specific influences.

Alternatively or additionally, it may also be provided that the time interval is also selected as a function of the predetermined resting position.

This enables particularly reliably approaching the predefined rest position. In particular, a variable rest position may be provided, which may be set, for example, by a user selection.

Alternatively or additionally, it may also be provided that the cutting assembly comprises a counter element to the first blade carrier, such as a second blade carrier or a cutting edge carrier, and in particular, as a function of a variable that is a measure of friction between the first blade carrier and the counter element, the rotational speed profile is determined and/or the time interval is selected.

This prevents the first blade carrier from braking more quickly due to friction by performing the braking of the first blade carrier at an adjusted start time according to the rotational speed curve.

For example, if there is a comparatively high friction between the first blade carrier and the counter element, the start point of the braking may be at a later point in time compared to situations where there is a comparatively low friction between the first blade carrier and the counter element. In both cases, however, the braking of the first blade carrier is performed based on the rotational speed profile and advantageously in the same way. This ensures that the predetermined rest position is reliably reached, as the different friction levels may be fully or partially compensated for by a different start point of the braking based on the rotational speed profile.

For example, the rotational speed of the motor may be the variable that is a measure of a friction between the first blade carrier and the counter element.

Further details regarding the cutting assembly will be discussed in more detail below.

Alternatively or additionally, it may also be provided that the predetermined rest position is reached at least partially and/or temporarily by driving the first blade carrier by means of the drive unit during at least one specific phase of the braking operation.

It has been shown that combining the method according to the second aspect of the disclosure with the method according to the first aspect of the disclosure offers particular advantages. In this case the discussed options of the method according to the first aspect of the disclosure may also be provided individually and in any combination in the method according to the second aspect of the disclosure. In particular, the driving of the first blade carrier by means of the drive unit and the specific phase of the braking operation may correspond to the driving and specific phase discussed above.

For example, the operation of the motor may, at least temporarily during the braking operation, at least implicitly, as a function of the determined motor position and/or the position of the first blade carrier, comprise a specific phase (and thus the driving of the first blade carrier by means of the drive unit). In particular, the specific phase during motor operation may occur according to the rotational speed profile.

In some examples, driving the first blade carrier during the specific phase may be part of operating the motor according to the rotational speed profile. That is to say, the specific rotational speed profile inherently requires driving the first blade carrier, so that the in particular the time-dependent actual rotational speed, follows the rotational speed profile.

Further options are described below which may be equally advantageously provided in the method according to the first aspect of the disclosure and in the method according to the second aspect of the disclosure.

For example, it may alternatively or additionally be provided that a rotational speed of the motor is reduced during at least a first part of the braking operation to a value of 40% or less than 40% of the rotational speed value existing at the start of the braking operation and/or to a value of 1% or more than 1% of the rotational speed value existing at the start of the braking operation.

In this way, braking of the motor from its initial rotational speed to a correspondingly reduced rotational speed value may be achieved in a in particular controlled and reliable manner. From this reduced rotational speed, further braking, especially to a standstill, may be performed reliably. For example, this further braking from the reduced rotational speed may be performed differently than during the first part of the braking operation.

The rotational speed of the motor may advantageously be reduced during at least the first part of the braking operation to a value of 30% or less than 30%, in particular to a value of 20% or less than 20%, in particular to a value of 10% or less than 10%, of the value of the rotational speed existing at the start of the braking operation.

It may be advantageously provided that during the first part of the braking operation, a profile of the rotational speed of the motor follows a non-increasing characteristic curve, in particular a characteristic curve that is either decreasing or horizontal in each section. This is also advantageous regardless of whether the aforementioned rotational speed limit of 40% or less than 40% is reached.

For example, it may alternatively or additionally be provided that the braking operation, in particular the first part of the braking operation, is performed at least temporarily as regenerative braking.

Through regenerative braking, the kinetic energy of the motor and/or the cutting assembly may be converted into electrical energy (and advantageously stored in an energy storage device, such as a battery) in order to brake at least the first blade carrier. For example, the recovered energy may be used, at least partially, to drive the first blade carrier during the specific phase, if intended.

It is advantageous if the braking operation during a specific phase, if provided, and especially during all specific phases, if provided, is performed as regenerative braking. In particular, the specific phase may be performed as regenerative braking at least temporarily, optionally continuously. It may also be advantageous if the first part of the braking operation is performed as regenerative braking at least temporarily. However, it is also advantageous if the entire first part of the braking operation is performed as regenerative braking.

For example, it may alternatively or additionally be provided that during at least one second part of the braking operation, in particular following the first part of the braking operation, in particular immediately, a short-circuit braking and/or a drag operation, in particular controlled, is performed, wherein optionally the first blade carrier is brought to a standstill by means of the short-circuit braking and/or the drag operation.

Short-circuit braking allows the cutting assembly, in particular the first blade carrier, to be brought to an abrupt, and therefore relatively quick, standstill, especially at low rotational speeds of the motor. To carry out short-circuit braking, the motor phases may be short-circuited, for example.

For example, drag operation may involve dragging the rotational speed of the motor to lower values, in particular by means of an electromagnetic rotating field. For example, a rotating field (especially a magnetic one) may be synchronized to the rotating rotor and/or the stator-fixed coordinate system (relative to the motor's stator) (such as during the transition from regenerative braking to drag operation), thereby braking the motor along a predefined trajectory.

For example, the predetermined rest position may be controlled at least partially by a combination of, on the one hand, driving the first blade carrier during the specific phase and/or operating the motor, at least implicitly as a function of the determined motor position and/or position of the first blade carrier, and on the other hand, short-circuit braking and/or drag operation (especially during the second part of the braking operation).

In some examples, the method comprises: performing a short-circuit braking and/or a, in particular controlled, drag operation, wherein optionally the first blade carrier is brought to a standstill by means of the short-circuit braking and/or the drag operation.

The method may advantageously comprise to brake the motor at least temporarily, and in particular continuously, in a position-controlled manner, especially during the first part of the braking operation, and in particular during the specific phase.

The method may comprise performing a determination of the position of the first blade carrier, in particular by coupling it to a flux observer angle.

The braking operation may, at least temporarily, in particular during the first part of the braking operation and/or the specific phase, comprise position-controlled braking of at least the first blade carrier.

It should be understood that it is expediently provided that the first blade carrier is set into working movement by means of the drive unit and/or that the first blade carrier is brought to a standstill in the predetermined rest position starting from the working movement.

The first blade carrier is advantageously set into the working movement by means of the drive unit until the start of the braking operation. Advantageously, the working movement of the first blade carrier ends with the start of the braking operation. Optionally, during the braking operation, in particular with the start of the braking operation until the first blade carrier comes to a standstill, the first blade carrier carries out a braking movement that advantageously follows the working movement immediately in terms of time.

For the purposes of this application, a blade carrier, such as the first blade carrier and/or the second blade carrier, is understood to mean an element, in particular a bar-shaped or disc-shaped element, on which one or more blades may be arranged or are arranged, in particular may be screwed on or are screwed on, or, are formed integrally. Advantageously, the thickness of the element, namely a dimension of the element proceeding perpendicular to a flat extent of the element, may be chosen to be small in comparison to a maximum dimension of the element within the flat extent of the element. For example, the thickness is then 30% of the maximum dimension or less than 30% of the maximum dimension, in particular 15% of the maximum dimension or less than 15% of the maximum dimension, in particular 5% of the maximum dimension or less than 5% of the maximum dimension. In particular, the thickness of the element is at least 0.001% of the maximum dimension of the element and/or at least 0.5 mm.

In one example, one or more blades are arranged on the first blade carrier or, in particular, are formed integrally with it. When this application states “blades of the first blade carrier”, this advantageously refers to such blades, regardless of the specific connection of the blades to the first blade carrier, unless the context indicates otherwise.

In one example, one or more projections are arranged or formed on the first blade carrier, of which at least some of the one or more projections each provide two blades, the cutting elements of which point in opposite directions in particular, wherein, in particular, a main direction of extension of each projection extends perpendicularly to a direction along which the working movement proceeds at least some of the time.

The command that triggers the braking operation may, for example, be initiated in response to an operator actuating a control unit.

The command in response to which the braking operation is performed may be a control command. The command in response to which the braking operation is performed may, for example, be received and/or identified. This may be done, for example, by receiving and/or evaluating a signal (such as via an interface) and identifying the command in response to receiving the signal and/or as a result of the evaluation. In particular, the command for this may be suitably encoded in the signal (and thus be advantageously accessible to evaluation) and/or suitably represented by the signal.

The drive unit may comprise the motor. The first blade carrier may be operatively connected with the motor (advantageously, the motor is coupled directly or indirectly to the first blade carrier), in particular in such a way that an actuation of the motor at least partially controls and/or causes a movement of the first blade carrier.

Alternatively or additionally, it may also be provided that the braking operation of the first blade carrier is performed as a function of at least one configuration parameter of the drive unit, such as a transmission ratio of a gearbox of the drive unit.

Such configuration parameters may be used to advantageously take into account mechanical, structural and/or other static parameters of the drive unit during the braking operation.

For example, the transmission ratio of the gearbox of the drive unit represents a gear reduction.

Alternatively or additionally, it may also be provided that at least one position of the motor shaft of the motor is detected and the braking operation of the first blade carrier is performed as a function of the at least one detected position.

Further alternatively or additionally, it may be provided that a plurality of positions of the motor shaft of the motor are detected and the braking operation of the first blade carrier is performed as a function of at least one of the detected positions.

In this application, a position (of the motor shaft) of the motor is understood to mean a, in particular relative or absolute, rotational position of the motor shaft of the motor. If the position presents a relative rotational position, the position may, for example, always have a value within a range A=[0 . . . 2π] (i.e. “modulo two pi”) during a continuous rotational movement of the motor shaft. If the position presents an absolute rotational position, the position may have a continuously increasing value during a continuous rotational movement of the motor shaft. If the position presents an absolute rotational position, the number of revolutions of the motor shaft may consequently be determined since a starting time.

The positions may advantageously be detected by means of a position encoder, for example a rotary encoder, such as an incremental encoder or an absolute encoder. Alternatively or additionally, the detection of the positions may also comprise an evaluation of at least the current and/or voltage values applied to the motor.

The positions may advantageously be detected in steps (angles of rotation) of at least 0.1° and/or at most 360°, for example, in steps of 1°, 5°, 10°, 15°, 45°, 90° or 180°.

The positions may be provided as an, in particular discrete-time, position signal. The position signal may then be reliably evaluated.

Alternatively or additionally, it may also be provided that a relationship between a time course of the position of the motor shaft of the motor on the one hand and a time course of the operating parameter signal on the other hand is determined or predetermined and the braking operation is performed as a function of the determined or predetermined relationship.

Alternatively or additionally, it may also be provided that an initial assignment is defined that describes or makes a position change of the motor shaft of the motor determinable, in particular a number of revolutions of the motor shaft of the motor, that is necessary to move the first blade carrier during the working movement from a specific position, in particular a position in which the first blade carrier is located in a reversal point and/or in a center position, in particular between two reversal points, to move it again to the specific position during the working movement.

For example, the first assignment may describe or make it determinable that the first blade carrier is located in a reversal point every X revolutions of the motor shaft.

In the case of a periodic working movement, it is also determinable from this after how many revolutions of the motor shaft the first blade carrier is again at the same reversal point.

Alternatively or additionally, it may also be provided that a second assignment is defined which describes or makes a position change of the motor shaft of the motor determinable, in particular a number of revolutions of the motor shaft of the motor, which is necessary to bring the first blade carrier to a standstill during the braking operation, starting from the working movement.

For example, the second assignment may describe or make it determinable that the first blade carrier is at a standstill after Y revolutions of the motor shaft from the working movement.

For example, the second assignment can or may be determined at least partially experimentally.

The counter element, in particular the second blade carrier and/or the cutting edge carrier, may be stationary or movable, for example.

In one example, the cutting assembly comprises the first blade carrier and the counter element, wherein the first blade carrier and the counter element are arranged one above the other (in particular along a direction perpendicular to a direction of working movement) and/or are movable relative to one another.

In one example, the cutting assembly comprises the first blade carrier and the second blade carrier (as a counter element). This configuration is also referred to as a double blade carrier and, in particular with regard to the respective blades, is also known in a hedge trimmer under the term sword.

In one example, one or more blades are arranged on the second blade carrier or, in particular, are formed integrally with it. When this application states “blades of the second blade carrier”, this advantageously refers to such blades, regardless of the specific connection of the blades to the second blade carrier, unless the context indicates otherwise.

In one example, one or more projections are arranged or formed on the second blade carrier, of which at least some of the more projections each provide two blades the cutting elements of which point in opposite directions in particular, wherein in particular a main direction of extension of the projections extends perpendicularly to a direction along which the working movement proceeds at least some of the time.

The second blade carrier is advantageously structurally designed to be identical to the first blade carrier, in particular including the blades each arranged or formed on it. The blades on the first and second blade carriers are advantageously arranged or formed in the same way. In this way, the two blade carriers, in particular including the blades each arranged or formed on them, may advantageously be brought into alignment with one another.

In particular, the first blade carrier is moved along the second blade carrier (for example, below or above the second blade carrier), at least during the working movement.

In one example, the cutting assembly comprises the first blade carrier and the cutting edge carrier (as a counter element).

In one example, one or more cutting edges are arranged on the cutting edge carrier or, in particular, are formed integrally with it. When this application states “cutting edges of the cutting edge carrier”, this advantageously refers to such cutting edges, regardless of the specific connection of the cutting edges to the cutting edge carrier, unless the context indicates otherwise.

One or more or all cutting edges may comprise cutting elements (and thus form blades). However, one or more or all cutting edges may also be blunt (and thus without cutting element).

In one example, fingers are arranged on the cutting edge carrier and/or, in particular, are formed integrally with it. The fingers represent cutting edges. This configuration is also referred to as a finger mower.

Optionally, the first blade carrier is moved, at least during the working movement, along the cutting edges (like fingers) (for example, below or above the cutting edges) or through the cutting edges (like fingers).

Alternatively or additionally, it may also be provided that the cutting assembly (i) is designed as a double blade carrier, in particular as a sword, or in the manner of a finger mower, (ii) is part of a power tool, such as a garden tool, a device used in landscape maintenance or in road maintenance depots and/or a device used in agriculture or forestry and/or (iii) (a) for processing, in particular pruning, of plants, in particular a hedge, a shrub, a bush and/or plants with a firm stem, (b) for mowing grass, grain and/or fruit and/or (c) for harvesting plants, in particular grass, grain, corn and/or rape.

The cutting assembly may, for example, be part of a hedge trimmer (as a garden tool) or of rotary shears.

The sword may, for example, be part of a hedge trimmer.

The double blade carrier may be formed at least partially by the first blade carrier and the second blade carrier.

The finger mower may be formed at least partially by the first blade carrier and the cutting edge carrier.

Alternatively or additionally, it may also be provided that a movement of the first blade carrier takes place relative to the counter element and/or the blades arranged or formed on the first blade carrier and the cutting edges and/or blades arranged or formed on the counter element interact when the processing and/or harvesting of plants is performed.

In this respect, for example, either the first blade carrier or the counter element may be stationary. For example, either the first blade carrier or the counter element or the first blade carrier and the counter element may be movable.

Optionally, one or more scissor-like elements are formed by the interaction of the blades arranged or formed on the first blade carrier and the (in particular blunt and/or sharp) cutting edges and/or blades arranged or formed on the counter element. These may then, for example, prune the plants or plant parts when processing and/or harvesting plants.

Alternatively or additionally, it may also be provided that a movement of the counter element is force-coupled to a movement of the first blade carrier.

So, when the first blade carrier moves, the counter element also moves, in particular in a predictable manner, and vice versa. A forced coupling of the movement may be implemented, for example, by a mechanical coupling of the first blade carrier and the counter element via a common drive wheel.

The advantage of a forced coupling is that the predetermined rest position of the first blade carrier may also be used to predetermine the rest position of the counter element.

Alternatively or additionally, it may also be provided that a movement of the first blade carrier takes place with an offset phase, in particular out of phase, to a movement of the counter element.

This may be implemented, for example, by means of a forced coupling, as described above.

Alternatively or additionally, it may also be provided that the predetermined rest position of the first blade carrier is selected from at least two possible rest positions of the first blade carrier, in particular by a user selection.

Alternatively or additionally, it may also be provided that the rest positions of the first blade carrier are defined relative to rest positions of the counter element.

Alternatively or additionally, it may also be provided that the working movement is a linear, rotating and/or oscillating movement and/or that the performing of the braking operation comprises or constitutes a control and/or regulation of the braking operation.

In one example, the working movement is a linear and oscillating movement.

In one example, the working movement is a rotating and oscillating movement.

In particular, an oscillating movement is understood to mean a “back and forth” movement. Examples of such a “back and forth” movement are a linear “back and forth” movement (back and forth) and a rotating “back and forth” movement (left and right about an axis of rotation). In particular, such an oscillating rotational movement between two reversal points may cover an angular range of less than 360°, for example, an oscillating rotational movement between two reversal points may cover an angular range of between 5° and 45°. However, such an oscillating rotational movement may also cover an angular range of 360° or more than 360° between two reversal points, for example an oscillating rotational movement may cover an angular range of between 540° and 720° between two reversal points (thus making about two revolutions in one direction, then again two revolutions in the other direction, and so on).

During the working movement also, the first blade carrier may also be temporarily in a state of rest. This is the case, for example, when the first blade carrier is at a reversal point in an oscillating working movement. As long as the first blade carrier is brought into a (short-term) state of rest as part of the working movement, the first blade carrier is not brought to a standstill within the meaning of a braking operation considered in this application, and accordingly no braking operation, as considered in the context of this application, takes place in this context.

Alternatively or additionally, it may also be provided that, in particular when looking at the cutting assembly along a defined viewing direction from below or from above, in a first possible rest position of the at least two possible rest positions of the first blade carrier (i) each of a plurality, in particular all, blades of the first blade carrier are each in a position in which they are at least partially or completely covered by a structure of the counter element defining a partner structure of the respective blade, in particular in the form of blades of the second blade carrier or cutting edge elements in each case, such as fingers, of the cutting edge carrier, at least in some areas or completely covered, and/or (ii) the blades of the first blade carrier are in a position in which the blades of the first blade carrier, in particular when looking at the cutting assembly along the defined viewing direction from below or from above, are located one above the other with the blades of the second blade carrier.

The first possible rest position is, in particular, a maintenance position. Since the blades of the first blade carrier are at least partially covered by the partner structures, a maintenance operation, such as sharpening the blades, may be more readily performed.

The structures of the counter element defining the partner structures may therefore be the blades arranged on or formed by the counter element (then in the form of the second blade carrier).

Alternatively or additionally, it may also be provided that, in particular when looking at the cutting assembly along the defined viewing direction from below or from above, in a second possible rest position of the at least two possible rest positions of the first blade carrier (i) each of a plurality, in particular all, of the blades of the first blade carrier is in each case in a position in which it (a) is offset with respect to its respective partner structure, in particular along a direction parallel to the working movement, and/or (b) is covered by its respective partner structure to a lesser extent than in the first rest position or is no longer covered by its respective partner structure, and in particular is not covered by one or more of the other partner structures, and/or (ii) the blades of the first blade carrier are in a position (a) in which the blades of the first blade carrier, in particular when looking at the cutting assembly along the defined viewing direction from below or from above, are offset with respect to the blades of the second blade carrier and/or (b) in which the blades of the first blade carrier are accessible for a grinding and/or cleaning operation and/or in which the blades of the two blade carriers do not stick.

The second possible rest position is advantageously a storage position. Since the blades of the first blade carrier are at least partially offset in relation to the partner structures, the elements of the cutting assembly are less likely to stick together. In addition, the blades are easily accessible for cleaning. The same applies to the blades of the second blade carrier as a counter element.

According to a third aspect, the disclosure proposes an assembly. in particular for a power tool, comprising a drive unit, which is or may be operatively connected to at least a first blade carrier of the cutting assembly and by means of which the first blade carrier may be set in a working movement, the assembly comprising a control unit which is or may be operatively connected to at least the drive unit, the assembly being configured to perform a method according to the first aspect of the disclosure and/or according to the second aspect of the disclosure.

All the advantages described in relation to the method according to the first aspect of the disclosure and the second aspect of the disclosure also apply accordingly to the assembly according to the third aspect of the disclosure. Therefore, reference may be made at this point to the previous explanations

The features described in relation to the method according to the first aspect of the disclosure and the second aspect of the disclosure may also be provided accordingly for the assembly, individually and in any combination, unless the context indicates otherwise.

In particular, the physical and functional configurations of the individual parts described in connection with the method according to the first aspect of the disclosure and the second aspect of the disclosure, as well as the structural and functional relationships described between the individual parts (such as the drive unit and the cutting assembly and their parts, such as in particular the first and second blade carrier and their blades) may also be provided in the assembly, individually and in any combination, unless the context indicates otherwise.

In particular, the control unit is configured to perform the method according to the first aspect of the disclosure and the second aspect of the disclosure. For this purpose, the control unit may interact with the other components of the assembly, in particular transmitting and receiving data. For example, the control unit may be configured to receive the command to initiate the braking operation and/or the operating parameter signal, to process, evaluate and/or analyze it and/or to transmit a control command, in each case as described in the present application, in particular in connection with the respective method according to the first and second aspect of the disclosure.

The control unit may be implemented, for example, in software, in hardware or as a combination of both. The control unit may be a device for processing data. Alternatively or additionally, the control unit may comprise a memory, a processor, a receiving unit, a transmitting unit or any combination thereof.

The control unit advantageously comprises interfaces for receiving the respective signals, such as the command for initiating the braking operation and/or the operating parameter signal, and/or means for processing, evaluating and/or analyzing the respective signals.

The control unit advantageously comprises interfaces for transmitting a control command to the drive unit, in particular to the motor or to the motor control. The control command may advantageously be used to regulate and/or control the drive unit, and in particular to perform the braking operation.

The control unit may advantageously be designed as part of the control unit of the motor of the drive unit or include the control unit.

Optionally, the control unit may also be operatively connected or connectable to the cutting assembly.

According to a fourth aspect, the disclosure proposes an arrangement comprising an assembly according to a third aspect of the disclosure and a cutting assembly comprising a first blade carrier, wherein the drive unit of the assembly is operatively connected or connectable with the first blade carrier of the cutting assembly.

All the advantages and options described in relation to the assembly according to the third aspect of the disclosure also apply accordingly to an arrangement according to the fourth aspect of the disclosure. Therefore, reference may be made at this point to the previous explanations.

According to a fifth aspect, the disclosure proposes a power tool, in particular a garden tool, in particular a device for use in landscaping, a device for use in road maintenance depots and/or a device used in agriculture or forestry, comprising an assembly according to the third aspect of the disclosure or an arrangement according to the fourth aspect of the disclosure, wherein (i) the power tool is operable by means of a battery and/or (ii) the power tool is designed as a hedge trimmer, a hedge cutter, a rotary trimmer, a sickle bar mower and/or a finger mower.

All the advantages and options described with regard to the assembly according to the third aspect of the disclosure and the arrangement according to the fourth aspect of the disclosure also apply accordingly to the power tool according to the fifth aspect of the disclosure. Therefore, reference may be made to the preceding explanations in this respect.

Further features and advantages of the disclosure will become apparent from the following description, in which examples of the disclosure are explained using schematic drawings.

### BRIEF DESCRIPTION OF THE DRAWINGS

FIG. 1 shows a schematic representation of a configuration according to the fourth aspect of the disclosure, comprising a cutting assembly and a drive unit;

FIG. 2a shows a schematic representation of the cutting assembly of FIG. 1 in a first configuration during a working movement;

FIG. 2b shows a schematic representation of the cutting assembly of FIG. 1 in a second configuration during the working movement;

FIG. 2c shows a schematic representation of the cutting assembly of FIG. 1 in a third configuration during the working movement;

FIG. 3 shows the time course of the rotational speed of the motor before and during the braking operation;

FIG. 4 shows a flowchart of a method according to the first aspect of the disclosure;

FIG. 5 shows a flowchart of a method according to the second aspect of the disclosure; and

FIG. 6 shows a schematic representation of a power tool according to the fifth aspect of the disclosure, comprising an assembly according to the third aspect of the disclosure or an arrangement according to the fourth aspect of the disclosure.

### DETAILED DESCRIPTION

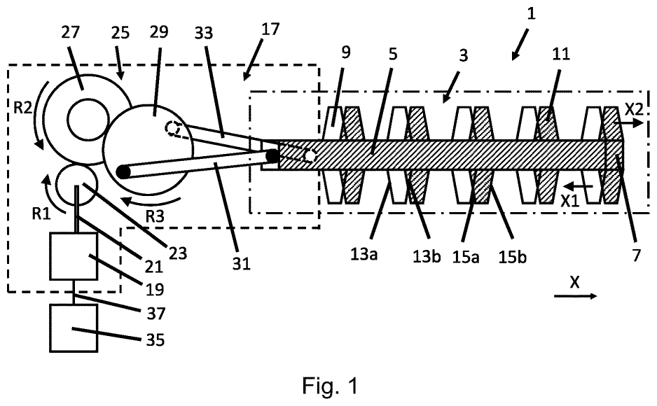

FIG. 1 shows a schematic representation of an arrangement 1 according to the fourth aspect of the disclosure.

Arrangement 1 comprises a cutting assembly 3 with a first blade carrier 5 and a counter element, presently in the form of a second blade carrier 7. In FIG. 1, the components of cutting assembly 3 depicted there are highlighted by a dashed common framing. First blade carrier 5 is intended along the viewing direction selected in FIG. 1 from above onto cutting assembly 3 above second blade carrier 7.

A plurality of blades 9 are formed integrally with first blade carrier 5. Likewise, a plurality of blades 11 are also formed integrally with second blade carrier 7. In FIG. 1, for the sake of clarity, only one blade of each blade carrier 5, 7 is provided with a reference symbol. Cutting elements 13a and 13b and 15a and 15b, respectively, are formed on two sides of blades 9 and 11 of first blade carrier 5 and second blade carrier 7, respectively.

Second blade carrier 7 and its blades 11 are hatched in FIG. 1, wherein part of second blade carrier 7 is covered by first blade carrier 5 and parts of blades 11 are also covered by blades 9.

The two blade carriers 5 and 7 are provided in cutting assembly 3 so that they may be moved relative to one another. This allows blades 9 and 11 of first and second blade carriers 5, 7 to be moved past each other. Due to the identical structure, the two blade carriers 5, 7, including their blades 9, 11, may be brought into alignment.

By means of a drive unit 17 of arrangement 1, first blade carrier 5 and second blade carrier 7 may each be set into a linear, oscillating working movement. This means that each of the two blade carriers 5 and 7 may be moved cyclically in parallel and anti-parallel to direction X and thus performs a periodic “back and forth” movement during operation. In FIG. 1, the components of drive unit 17 depicted there are highlighted by a dashed common framing.

If the two blade carriers 5 and 7 move against each other and their blades 9 and 11 also move against each other during the working movement, two blades from different blade carriers 5, 7 in each case work together in pairs and temporarily, thus functionally implementing a plurality of shears. Thus, for example, it is possible to process, in particular to prune, plants, in particular a hedge, a bush, a shrub and/or plants with firm stems.

Drive unit 17 comprises a motor 19 with a motor shaft 21 that may rotate about an axis of rotation. Motor shaft 21 is coupled to a first gear wheel 23 of a gearbox 25 of drive unit 17, so that first gear wheel 23 may be set in a rotational movement along a direction R1 by a rotational movement of motor shaft 21. The rotational movement of first gear wheel 23 in direction R1 causes a second gear wheel 27 of gearbox 25, coupled to the first gear wheel 23, to be set in a rotational movement along a direction R2, and thus causes a third gear wheel 29 of gearbox 25, coupled to second gear wheel 27, to be set in a rotational movement along a direction R3. The fact that motor shaft 21 in FIG. 1 is not perpendicular to the plane of the illustration is due to the schematic nature of the figure.

Third gear wheel 29 is coupled by a first coupling means 31 (which engages with it on the side of third gear wheel 29 facing the observer in FIG. 1) to first blade carrier 5 and by a second coupling means 33 (which engages with it on the side of third gear wheel 29 facing away from the observer in FIG. 1) to second blade carrier 7, each in a movable manner.

If third gear wheel 29 is rotated further along direction R3, starting from the position shown in FIG. 1, first blade carrier 5 is moved along the negative X-direction (direction X1) in FIG. 1 to the left and second blade carrier 7 is moved along the positive X-direction (direction X2) in FIG. 1 to the right.

By means of coupling means 31, 33 and due to their interaction with third gear wheel 29 and blade carriers 5, 7, a rotational movement of third gear wheel 29 may be used to set each of two blade carriers 5, 7 in a linear, oscillating movement in such a way that the movements of two blade carriers 5, 7 are in opposite phases (i.e. a phase offset of 180°) to each other. So, if first blade carrier 5 is at the left reversal point (i.e. has moved as far as possible in the negative X direction), second blade carrier 7 is at the right reversal point (i.e. has moved as far as possible in the positive X direction), and vice versa.

Since both blade carriers 5, 7 are coupled to the same third gear wheel 29 via coupling means 31, 33, as described, second blade carrier 7 performs a movement that is positively coupled to the movement of first blade carrier 5. If the position of first blade carrier 5 is fixed, the position of second blade carrier 7 is also fixed.

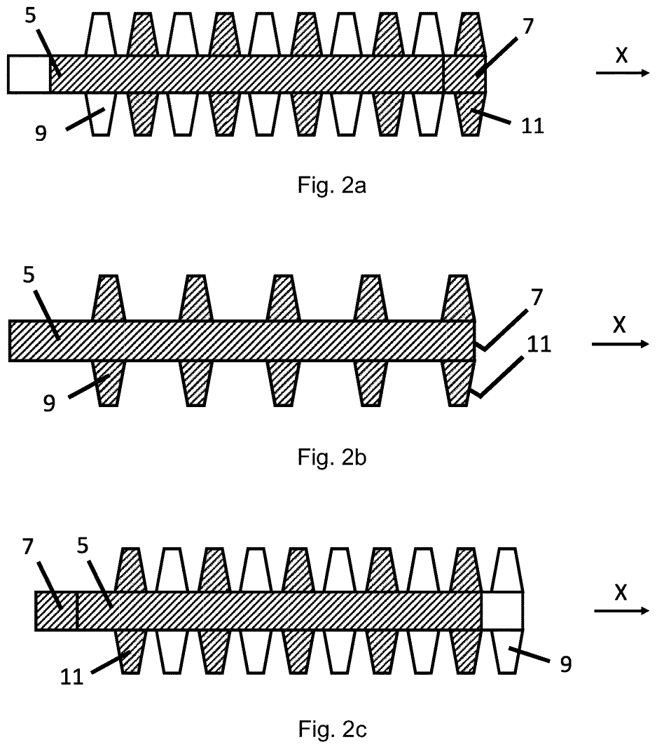

FIG. 2a-2c show schematic representations of cutting assembly 3 of FIG. 1 in which the two blade carriers 5 and 7 each assume different positions relative to each other as they move relative to each other. The viewing direction continues to be from above onto cutting assembly 3.

During a complete movement cycle (in which third gear wheel 29 makes a complete revolution), at a first point in time (at which third gear wheel 29 has a first rotational position), first blade carrier 5 is maximally deflected to the left and thus at its left reversal point, and second blade carrier 7 is maximally deflected to the right and thus at its right reversal point. The configuration is shown in FIG. 2a.

At a later second point in time (at which third gear wheel 29 has a second rotational position), first blade carrier 5 was moved to the right and second blade carrier 7 was moved to the left, and both blade carriers are in alignment with each other. In fact, each of the two blade carriers 5, 7 is in a center position, which is centered between the two reversal points. The configuration is shown in FIG. 2b. Since second blade carrier 7, including its blade 11, is completely covered by first blade carrier 5 and its blade 9, second blade carrier 7 and its blade 11 are not visible in FIG. 2b.

At a later third point in time (at which third gear wheel 29 has a third rotational position), first blade carrier 5 in FIG. 2a has been moved further to the right up to its right reversal point and second blade carrier 7 has been moved further to the left up to its left reversal point. The configuration is shown in FIG. 2c.

In the second half of the (one) movement cycle, the configuration depicted in FIG. 2b is first assumed again and then the configuration depicted in FIG. 2a is assumed again.

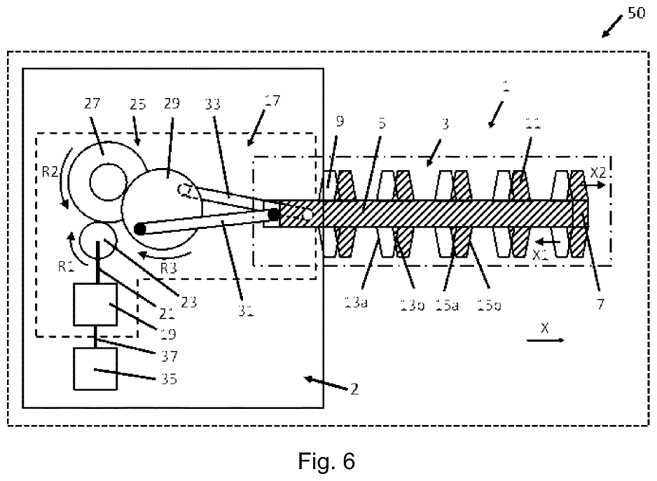

After using arrangement 1, which may be provided as part of a power tool 50 (shown in FIG. 6), such as a hedge trimmer, for example, wherein in the case of a hedge trimmer cutting assembly 3 is also referred to as a sword, it may be desirable to clean and/or sharpen blades 9, 11. Particularly good accessibility of blades 9, 11 is achieved when the two blade carriers 5, 7 are positioned relative to each other as depicted in FIGS. 2a and 2c. On the other hand, it may be desirable for the transport of arrangement 1 that blades 9, 11 are located one above the other, which is the case with a position of two blade carriers 5, 7 relative to each other as depicted in FIG. 2b.

Therefore, it may be predetermined in which rest position of the two possible rest positions of first blade carrier 5 (relative to second blade carrier 7) first blade carrier 5 is brought to a standstill from the working movement. For this purpose, arrangement 1 may advantageously comprise a user interface or be operatively connected with such interface, in order to receive a user selection regarding the selected rest position.

In other words, while first blade carrier 5 (relative to second blade carrier 7) is moving as part of a working movement (and is thereby moving back and forth periodically between its reversal points), a braking operation is initiated in response to a command, starting from the working movement, in such a way that the selected rest position of first blade carrier 5 (relative to second blade carrier 7) is approached and first blade carrier 5 is brought to a standstill there. As a function of the selected rest position, blades 9, 11 of the two blade carriers 5, 7 are then either one above the other (as illustrated in FIG. 2b) or offset from one another (as illustrated in FIG. 2a or 2c).

To make this possible, arrangement 1 comprises a control unit 35 that is or may be operatively connected to drive unit 17. By means of control unit 35, a movement of first and second blade carriers 5, 7 may be checked, in particular regulated and/or controlled, and thus the braking operation of first blade carrier 5, 7 (and with it that of the second blade carrier) may be checked, in particular regulated and/or controlled.

For this purpose, control unit 35 may receive, via data line 37, an operating parameter signal relating to the rotational speed of motor 19. Based on this, control unit 35 can determine the value of the motor speed, so that the braking operation may be performed as a function of the determined value. The operating parameter signal is, in the present case, a control unit signal and is provided by a control unit of the motor 19 via data line 37.

Control unit 35 therefore also comprises interfaces for receiving, among other things, the operating parameter signal and means for processing, evaluating and analyzing the operating parameter signal.

First blade carrier 5 is then driven by drive unit 17 during at least one specific phase of the braking operation, as a function of the determined value. In particular, the drive intensity is adjusted during the specific phase as a function of the determined value of the rotational speed, and thus ultimately as a function of the friction. By driving during the specific phase, the braking effect of friction may be fully or at least partially compensated. This allows the predetermined rest position to be reliably reached despite varying friction between first blade carrier 5 and second blade carrier 7.

If, for example, the determined value of the rotational speed is lower than that of an expected planned rotational speed, this may indicate comparatively high friction. Correspondingly strong driving first blade carrier 5 during the specific phase may then compensate for the additional braking of first blade carrier 5 caused by this friction.

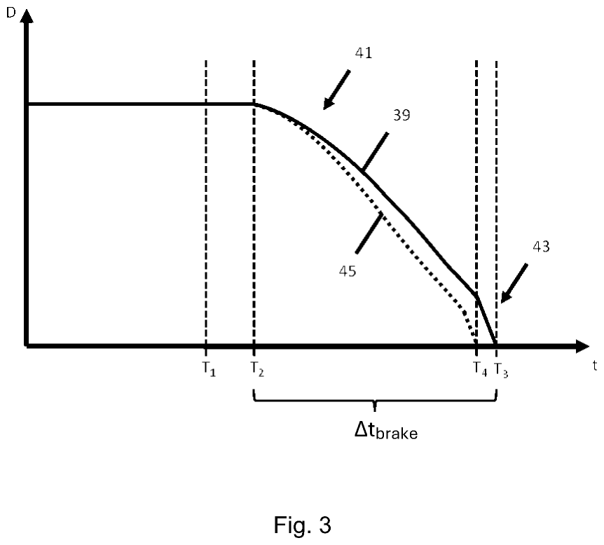

FIG. 3 shows, as a solid line, a time course 39 of the rotational speed of motor 19 before and during the braking operation. The axes of the diagram are rotational speed D and time t.

Initially, motor 19 is operated at a constant rotational speed (horizontal portion of curve 39). At time T₁, a command to perform the braking operation is received. This command may, for example, be triggered by an operator of arrangement 1. The braking operation then commences at time T₂ and continues until the first blade carrier 5 comes to a standstill in the predetermined rest position at time T₃, i.e., during a time interval Δt_{brake}. The time interval between T₁ and T₂ may, for example, be determined by signal processing. However, the time interval between T₁ and T₂ in FIG. 3 is purely schematic and may, in reality, be chosen to be very small and/or approach zero compared to the entire braking operation. During first part 41 of the braking operation, which begins at time T₂ and ends at time T₄, the first blade carrier is driven as a function of the determined value of the motor rotational speed. This first part 41 is performed as regenerative braking, despite driving first blade carrier 5. At the end of first part 41 of the braking operation, that is to say, at time T₄, the rotational speed of motor 19 is reduced to a value of 40% (or alternatively less than 40%) of the value of the rotational speed existing at the start of the braking operation at time T₂.

During a second part 43 of the braking operation, which immediately follows first part 41, a short-circuit braking action is performed on first blade carrier 5. Second part 43 therefore begins at time T₄ and ends at time T₃. This short-circuit braking action brings first blade carrier 5 (and, due to the forced coupling, also second blade carrier 7) to a standstill. Since the short-circuit braking action of second part 43 of the braking operation is performed from a rotational speed reduced to (at least) 40%, the predetermined rest position of first blade carrier 5 may be reliably reached.

Presently, the specific phase lasts the entire duration of first part 41 of the braking operation, that is to say, from T₂ to T₄. However, in other examples, a plurality of specific phases may be provided, which do not all follow each other immediately. This results in time intervals during first part 41 of the braking operation in which first blade carrier 5 is not driven. For example, in this context, one or more rotational speed values may be determined during the braking operation, in particular periodically. If individual determined values do not indicate any unforeseen friction, driving may be suspended, at least temporarily, based on these determined values.

FIG. 3 also shows a time course 45 of the rotational speed of motor 19 during a conventional braking operation, indicated by a dashed line. A comparison of the two profiles 39 and 45 reveals that, due to driving first blade carrier 5 during the specific phase, profile 39 is flatter than profile 45, at least during first part 41 of the braking operation. Therefore, during the conventional braking operation, first blade carrier 5 comes to a standstill earlier. However, since this occurs uncontrolled, the desired, predetermined rest position is missed or only reached by chance.

To ensure that the predetermined rest position is reliably reached despite varying friction, the braking operation may also be advantageously performed in another way. In this case, first blade carrier 5 is not necessarily driven, as just described. Instead, in response to the command, a position of motor 19 and/or a position of first blade carrier 5 is determined, and motor 19 is operated, at least temporarily during the braking operation, at least implicitly, as a function of the determined motor position and/or the position of first blade carrier 5.

For example, a time course of a rotational speed of motor 19 can be determined as a rotational speed profile, and the motor may be operated according to the rotational speed profile, at least temporarily during the braking operation. The rotational speed profile could, for example, correspond to profile 39 shown in FIG. 3 in first part 41 of the braking operation. This allows the rotational speed profile to be adjusted to the specific situation. Second part 43 of the braking operation, involving short-circuit braking, could also be provided accordingly.

The rotational speed profile may be determined, for example, as a function of the determined motor position and/or the position of first blade carrier 5 and/or the predetermined rest position. This means that motor 19 is operated, at least implicitly, as a function of the determined motor position and/or the position of first blade carrier 5. The rotational speed profile may then have a different shape as a function of the friction. Alternatively or additionally, a starting time for braking first blade carrier 5 may be adjusted based on the rotational speed profile according to a time interval selected as a function of the determined motor position and/or the position of first blade carrier 5 and/or the rotational speed profile. In other words, the starting time (from which the motor is operated according to the rotational speed profile) is shifted backward (or, in principle, forward in the direction of time T₁). In profile 39 shown in FIG. 3, time T₂ would therefore be shifted backward (or forward) (and consequently, usually also time T₃ and time T₄). By adjusting the start time, the friction between first blade carrier 5 and second blade carrier 7 may be advantageously taken into account. In particular, an identical rotational speed profile may always be determined (for example, the same rotational speed profile may always be retrieved from a memory), so that by shifting the start time, the friction may be taken into account in particular easily and reliably, and the predetermined rest position may be reliably reached.

However, it may also be advantageous to combine both aspects and thus to perform both driving first blade carrier 5 during the specific phase and the operation of motor 19 at least implicitly as a function of the determined motor position and/or position of first blade carrier 5.

In some examples, drive unit 17 may also have a completely or at least partially different structure. In some examples, drive unit 17 may comprise fewer or more gears than the three gears 23, 27, 29 shown in FIG. 1.

Although in cutting assembly 3 described with reference to FIG. 1, both first blade carrier 5 and second blade carrier 7 are movable and both may be set in a working movement by drive unit 17, in some examples only first blade carrier 5 may be movable and only this may be set in a working movement by drive unit 17. Then, second blade carrier 7 may be provided in a fixed (immobile) manner in cutting assembly 3. Therefore, in the previous explanations, it always depends only on the relative movement of first and second blade carriers 5, 7 to one another.

In each case, drive unit 17 sets first blade carrier 5 into a working movement relative to second blade carrier 7, which is a linear, oscillating movement.

In the previous explanations regarding the figures, the counter element was described as a second blade carrier 7. In some examples, the counter element may also be formed as a cutting edge carrier instead of a blade carrier. In this case, cutting edges may be arranged or formed on the cutting edge carrier instead of blades 11. The cutting edges then interact with blades 9 of first blade carrier 5.

Arrangement 1 may be provided in a power tool 50.

Arrangement 1 may be provided, for example, in a garden tool, such as a hedge trimmer. In a hedge trimmer, the cutting assembly is also referred to as a sword. In a hedge trimmer, the first blade carrier and counter element (such as a second blade carrier) are typically bar-shaped.

Arrangement 1 may also be provided, for example, in rotary shears, such as those used as garden tools or as a device in landscape maintenance or in road maintenance depots. In case of rotary shears, the blade carrier and counter element are typically disc-shaped.

Arrangement 1 may also be provided, for example, in a device used in agriculture. The cutting assembly is then advantageously designed as a finger mower (with fingers on the counter element).

It should be noted that, according to the third aspect of the disclosure, an assembly 2 (shown in FIG. 6) may comprise precisely described drive unit 17 and control unit 35 operatively connected thereto. Therefore, the formulation that arrangement 1 comprises drive unit 17 and control unit 35 is identical in content to the formulation that arrangement 1 comprises an assembly 2 which in turn comprises drive unit 17 and control unit 35.

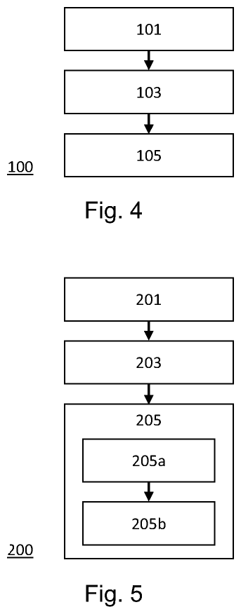

FIG. 4 shows a flowchart 100 of a method according to the first aspect of the disclosure.

In 101, a first blade carrier in a cutting assembly is set into a working movement by means of a drive unit.

In 103, a command to initiate a braking operation is received (for example, from a user interface) and/or identified.

In 105, the braking operation of at least the first blade carrier is performed such that the first blade carrier is brought to a standstill in a predetermined rest position. The predetermined rest position is reached at least partially and/or temporarily by driving the first blade carrier by means of the drive unit during at least one specific phase of the braking operation.

FIG. 5 shows a flowchart 200 of a method according to the second aspect of the disclosure.

In 201, a first blade carrier in a cutting assembly is set into working movement by means of a drive unit.

In 203, a command to initiate a braking operation is received (for example, from a user interface) and/or detected.

In 205, the braking operation of at least the first blade carrier is performed such that the first blade carrier is brought to a standstill in a predetermined rest position. In this case, in 205a, in response to the command, a position of a motor of the drive unit and/or a position of the first blade carrier is determined. In 205b, the motor is operated, at least temporarily during the braking operation, at least implicitly, as a function of the determined motor position and/or the position of the first blade carrier.

The predetermined rest position is reached at least partially and/or temporarily by driving the first blade carrier by means of the drive unit during at least one specific phase of the braking operation.

Another example of a method according to the second aspect of the disclosure, applied to a power tool, may, for example, comprise the following steps:
1. The power tool is operating normally.
2. A position determination of the first blade carrier is performed during normal operation and/or a coupling to a flux observer angle is performed.
3. A command to initiate a braking operation of the first blade carrier is detected (previously, for example, an operator has actuated a switch).
4. A rotational speed profile for braking is determined and/or braking is started at a suitable blade and/or motor position.
5. The braking, based on the rotational speed profile, is performed as regenerative braking until a certain reduced rotational speed is reached.
6. A short-circuit braking/drag operation is performed to bring the first blade carrier to a standstill in a predetermined rest position.

Another example of a method according to the second aspect of the disclosure, applied to a power tool, may, for example, comprise the following steps:
1. The power tool is operating normally.
2. A position determination of the first blade carrier is performed during normal operation and/or a coupling to a flux observer angle is performed.
3. A command to initiate a braking operation of the first blade carrier is detected (previously, for example, an operator has actuated a switch).
4. The braking is delayed until a motor position is reached from which, by braking the motor according to a previously determined rotational speed profile, the first blade carrier may be moved into a defined position, and the braking is then started.
5. The braking is performed as regenerative braking until a certain reduced rotational speed is reached.
6. A short-circuit braking/drag operation is performed to bring the first blade carrier to a standstill in a predetermined rest position.

FIG. 6 shows a schematic representation of a power tool 50 according to the fifth aspect of the disclosure, comprising an assembly 2 according to the third aspect of the disclosure or an arrangement 1 according to the fourth aspect of the disclosure. Assembly 2 comprises drive unit 17 and control unit 35 operatively connected thereto. Furthermore, power tool 50 may comprise a battery (not shown) for driving drive unit 17.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A method for performing a braking operation of at least a first blade carrier in a cutting assembly of a power tool, wherein the first blade carrier is set into a working movement by means of a drive unit and, in response to a command, the braking operation of at least the first blade carrier is performed in such a way that the first blade carrier is brought to a standstill in a predetermined rest position, wherein the predetermined rest position is reached at least partially or temporarily by driving the first blade carrier by means of the drive unit during at least one specific phase of the braking operation.

2. The method according to claim 1, wherein the braking operation is performed as at least one of a function of at least one operating parameter of a motor of the drive unit, or at least one characteristic variable of the first blade carrier, wherein the at least one operating parameter is a rotational speed or a position of the motor, and wherein the at least one characteristic variable is a position of the first blade carrier.

3. The method according to claim 2, wherein at least one value of the operating parameter or the characteristic variable is determined, in terms of time, after the command in response to the command, and wherein a duration of the at least one specific phase or a drive intensity of the first blade carrier by means of the drive unit is determined based on the value of the operating parameter or the characteristic variable.

4. The method according to claim 3, wherein the cutting assembly comprises a counter element to the first blade carrier, such as a second blade carrier or a cutting edge carrier, and the operating parameter or the characteristic variable or a variable derived therefrom is a measure of friction between the first blade carrier and the counter element.

5. The method according to claim 1, wherein a drive intensity is varied as a function of time during the at least one specific phase.

6. The method according to claim 1, wherein the at least one specific phase is at least two specific phases, and wherein the predetermined rest position is reached at least partially or temporarily by driving the first blade carrier by means of the drive unit during the at least two specific phases of the braking operation, wherein at least two of the at least two specific phases do not follow each other immediately in terms of time.

7. The method according to claim 1, wherein a duration of all of the at least one specific phases is less than a duration of the braking operation, wherein the duration of all of the at least one specific phases is at most 95% of the duration of the braking operation or at least 1% of the duration of the braking operation.

8. The method according to claim 2, wherein the rotational speed of the motor is reduced during at least a first part of the braking operation to a value of 40% or less than 40% of the value of the rotational speed existing at a start of the braking operation or to a value of 1% or more than 1% of the value of the rotational speed existing at the start of the braking operation.

9. The method according to claim 8, wherein the first part of the braking operation comprises the specific phase, and (i) the specific phase represents a start or an end of the first part of the braking operation, or (ii) the specific phase is temporally separated from the start and the end of the first part of the braking operation.

10. The method according to claim 8, wherein the braking operation, the first part of the braking operation, is performed at least temporarily as regenerative braking.

11. The method according to claim 8, wherein, during at least one second part of the braking operation, following the first part of the braking operation, immediately thereafter, at least one of a short-circuit braking or a, controlled, drag operation is performed, wherein preferably the first blade carrier is brought to a standstill by at least one of the short-circuit braking or the drag operation.

12. An assembly, for a power tool, comprising a drive unit which is or may be operatively connected to at least a first blade carrier of a cutting assembly and by means of which the first blade carrier may be set in a working movement, wherein the assembly comprises a control unit which is or may be operatively connected to at least the drive unit, wherein the assembly is configured to perform the method of claim 1.

13. The assembly of claim 12, further comprising an arrangement, wherein the drive unit of the assembly is or may be operatively connected with at least the first blade carrier of the cutting assembly.

14. The assembly of claim 12, wherein the assembly is for the power tool and is operable by means of a battery or the assembly is designed as a hedge trimmer, a hedge cutter, a rotary trimmer, a sickle bar mower or a finger mower.

15. A power tool having a cutting assembly and a drive unit, which is or can be operatively connected to at least a first blade carrier of the cutting assembly and by means of which the first blade carrier can be set in a working movement, the power tool comprising a control unit which is or can be operatively connected to at least the drive unit, the power tool being configured to carry out a method for a braking operation of at least the first blade carrier of the cutting assembly, wherein the first blade carrier is set into a working movement by means of a drive unit and, in response to a command, the braking operation of at least the first blade carrier is performed in such a way that the first blade carrier is brought to a standstill in a predetermined rest position, wherein the predetermined rest position is reached at least partially or temporarily by driving the first blade carrier by means of the drive unit during at least a specific phase of the braking operation.

16. The power tool of claim 15, wherein the power tool is operable by means of a rechargeable battery.

17. The power tool of claim 15, wherein the power tool is formed as a hedge trimmer, a hedge cutter, a rotary trimmer, a sickle bar mower, or as a finger mower.
